(19) United States
(12) Patent Application Publication
(10) Pub. No.: US 2003/0118430 A1
(43) Pub. Date: Jun. 26, 2003

(54) Automatic stacking mechanism

(76) Inventors: Robert G. Braaten, Owatonna, MN (US); Kurt Bernard Snaza, Owatonna, MN (US)

Correspondence Address: MOORE, HANSEN & SUMNER, 2900 WELLS FARGO CENTER, 90 SOUTH SEVENTH STREET, MINNEAPOLIS, MN, 55402, US

(21) Appl. No.: 10/027,959

(22) Filed: Dec. 20, 2001

(51) Int. Cl. B65G 69/00

(52) U.S. Cl. 414/659; 414/790.3

(57) ABSTRACT

An apparatus for creating an ordered stack of bags is herein disclosed. A stack apparatus according the present invention comprises a stacking conveyor mounted within a framework constructed and arranged such that the stacking conveyor is moveable vertically and laterally with respect to the framework. The stacking conveyor is moveable between a bag receiving position in which a filled bag is deposited on the input end of the conveyor and any one of a number of vertically and laterally predefined stacking positions in which the stacking conveyor conveys the filled bag onto a stack. The present invention may have a self adjusting supply conveyor secured directly thereto to obviate the need to return to a distinct bag receiving position. In addition, the stacking apparatus may be used in conjunction with a moveable skid for stacking bags in locations remote from the stacking apparatus, or may be constructed and arranged from movement directly to a location where bags are to be stacked.

### FIELD OF THE INVENTION

The present invention is drawn to a mechanism for at least partially automating the filling of shipping containers and the like. More specifically, the present invention is a mechanism for automatically stacking bags or containers on a moveable skid that may be used to place the stacked bags or containers within a defined space without need for a pallet or hand stacking.

### BACKGROUND OF THE INVENTION

When shipping bulk commodities, it is often desirable to maximize the amount of the commodity that may be placed in a single space or container. Accordingly, it is often the practice of many shippers to omit the use of pallets in shipping commodities in order to maximize the number of bags, boxes, or other receptacles that can be fit into a give space. However, where pallets are omitted, it is necessary to stack the commodities by hand. Given the strenuous nature of hand stacking commodities on a continuous basis, it is no wonder that increased manpower costs will diminish any returns garnered in omitting the use of pallets in stacking.

Accordingly, it is an objective of the present invention to provide a stacking mechanism that greatly reduces the amount of manpower required to stack bags, boxes, or other receptacles in a predefined space. Another objective of the present invention is to provide a stacking mechanism that obviates the need for hand stacking of bags, boxes or other receptacles in the filling of shipping containers and the like without the use of pallets. It is yet another object of the present invention to provide a stacking mechanism that speeds the process of stacking bags, boxes or similar receptacles within a shipping container or the like.

These and other objectives and advantages of the invention will appear more fully from the following description, made in conjunction with the accompanying drawings wherein like reference characters refer to the same or similar parts throughout the several views.

### SUMMARY OF THE INVENTION

The objectives of the present invention have been met in the provision of an apparatus for creating an ordered stack of bags in a predefined arrangement that is comprised of a conveying mechanism and a queuing mechanism that work in conjunction with one another to rapidly stack bags, boxes and the like in a predefined space without the need for pallets or hand stacking.

In one embodiment of the present invention, the conveying mechanism has an input end and an output end. Bags or the like move along the conveying mechanism from its input end to its output end. The conveying mechanism is laterally moveable with respect to the direction of travel of the bags passing thereover. When the conveying mechanism is in its bag pick up position, bags are received onto the conveying mechanism from a bag supply mechanism. From the bag receive position, the conveying mechanism is capable of moving to any of a number of predefined bag deposition positions in which the output end of the conveying mechanism is positioned to deposit a bag in a predefined stack position upon the queuing mechanism. Preferably, the conveying mechanism is a first powered conveyor that is constructed and arranged to receive bags from a second powered conveyor when the conveying mechanism is in its bag receiving position. It is also preferred that the powered conveyor of the conveying mechanism be capable of conveying bags at a speed sufficient to convey a bag entirely onto the queuing mechanism, i.e. can loft bags onto the queuing mechanism. In order to speed the stacking operations, it may be useful to construct the conveying mechanism so as to be moveable between at least two queuing mechanism stations, each station being a location wherein a queuing mechanism can be positioned awaiting the stacking of boxes therein. Rather than idling the conveying mechanism once a queuing mechanism is full and taken away to deposit is load in a shipping container, etc., the conveying mechanism may be rotated, slid, or otherwise moved to a second, third, etc., position to address and fill multiple queuing mechanisms.

The queuing mechanism receives bags or the like from the output end of the conveying mechanism in one of a number of predefined stacking orders. The queuing mechanism has a bottom and two opposing sides that extend upwardly from the lateral edges of the bottom. The queuing mechanism also has a back wall positioned between the sides thereof such that in moving from a rearmost position located generally away from the conveying mechanism to a forward position, any bags that have previously been deposited on the bottom of the queuing mechanism will be ejected therefrom. In order to receive bags from the conveying mechanism, the back wall of the queuing mechanism must be in its rearmost position. In one embodiment of the present invention, the queuing mechanism is vertically moveable with respect to the conveying mechanism so as to permit successive layers of bags to be deposited within the queuing mechanism by the conveying mechanism. Vertical movement of the queuing mechanism is facilitated by an indicating mechanism that conveys positioning information concerning the position of the queuing device with respect to the conveying mechanism.

The queuing mechanism is typically mounted on a materials handling vehicle such as a fork truck or stacker that is capable of moving the queuing mechanism from a loading position wherein the queuing mechanism is positioned adjacent the conveying device to a stacking position wherein bags stacked on the queuing device are expelled from the queuing device by the movement of the back wall of the queuing device from its rearmost position to its forward position. It is contemplated that the present invention may be used to stack bags, boxes, and the like in railcars, shipping containers, truck trailers, warehouse bays, and any other location in which one needs to stack items.

In a more preferred embodiment, the apparatus for creating an ordered stack of bags comprises a conveyor and a skid. The conveyor is mounted within a framework that is constructed and arranged such that the conveyor is moveable along a substantially vertical axis and also laterally with respect to the vertical axis. The conveyor has an input end and an output end. The skid has a bottom, two opposing sides that extend upwardly from the lateral edges of the bottom, and a back wall that is moveable between a first position located adjacent a back edge of the skid and a second position located adjacent a front edge of the skid. The conveyor is moveable from a bag receiving position in which a filled bag or the like is deposited on the input end of the conveyor and one of a number of vertically and laterally predefined stacking positions in which the conveyor conveys the filled bag onto the skid in one of the predefined stacking positions. The back wall of the skid must generally be in its first position as filled bags are deposited on the skid by the output end of the conveyor. The bags deposited on the skid are subsequently expelled from the skid as the back wall moves from its first position to its second position. In this more preferred embodiment, the skid remains stationary as filled bags are deposited thereon by the moveable conveyor. Each filled skid is mounted to a materials handling device capable of moving the skid from a loading position adjacent the output end of the conveyor to an unloading position where the filled bags stacked on the skid are expelled therefrom by the action of the back wall moving from its first position to its second position. As can be appreciated, the skid may be unloaded in any number of locations, including, but not limited, a shipping container, an airplane cargo hold, a warehouse bay, a railcar, a trailer, and a hold of a ship. In addition, the apparatus is capable of stacking bags, boxes, or other types of containers in an interlocked or columnar fashion. Typically, the skid will stack the bags, etc., in tiers.

A controlling mechanism directs the conveyor between its bag receiving position and the vertically and laterally predefined stacking positions. The controlling mechanism is preferably a computer that automatically stacks the bags according to a preselected bag-stacking algorithm. However, it is contemplated that an operator may control the vertical and lateral position of the conveyor using a simple joystick type arrangement.

The preferred embodiment of the present invention may also comprise a support mechanism for moveably supporting the framework upon which the conveyor is supported. The support mechanism is constructed and arranged to move the conveyor between a plurality of stacking stations. The support mechanism can support the framework in which the conveyor is mounted in diverse ways, including, but not limited to rails, wheels, and treads. In addition, the support mechanism can move the framework upon which the conveyor is mounted along linear or curvilinear paths.

### DESCRIPTION OF THE DRAWINGS

FIG. 1 is a schematic representation of how bags, boxes, or the like are hand stacked within a shipping container.

FIG. 2 is an illustration of how bags, boxes, or the like are stacked within a shipping container using the stacking apparatus of the present invention.

FIG. 3 illustrates how two tiers of bags, boxes, or the like may be stacked simultaneously using the stacking apparatus of the present invention.

FIG. 4 is a front elevation of a skid having bags stacked thereon in an interlocking arrangement;

FIG. 4b is a front elevation of a skid having bags stacked thereon in a columnar fashion;

FIG. 5 is a side view of a skid mounted upon a materials handling device wherein the back wall of the skid is moving from its rearmost position to its forward position;

FIG. 6 is a top plan view of an embodiment of the present invention showing a supply conveyor, a moveable stacking conveyor, and a skid mounted on a fork truck;

FIG. 7 is a side view of the embodiment illustrated in FIG. 6 wherein the skid is vertically positioned by the fork truck to which it is mounted;

FIG. 8 is a top plan view of a preferred embodiment of the present invention illustrating a supply conveyor, stacking conveyor and a skid mounted to a fork truck;

FIG. 9 is a side view of the preferred embodiment of FIG. 8;

FIG. 10 is a front elevation of the stacking conveyor of FIG. 8;

FIG. 11 is a top plan view of an alternate embodiment of the stacking 15 apparatus in which the stacking conveyor is moveable between multiple stacking stations;

FIG. 12 is a top plan view of a preferred embodiment of the present invention including a supply conveyor, a stacking conveyor assembly, and a skid;

FIG. 13 is a side elevation of the embodiment illustrated in FIG. 20;

FIG. 14 is an alternate embodiment of the present invention, including a supply conveyor, a stacking chute and a skid; and,

FIG. 15 is a side elevation of the embodiment illustrated in FIG. 13.

### DETAILED DESCRIPTION

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

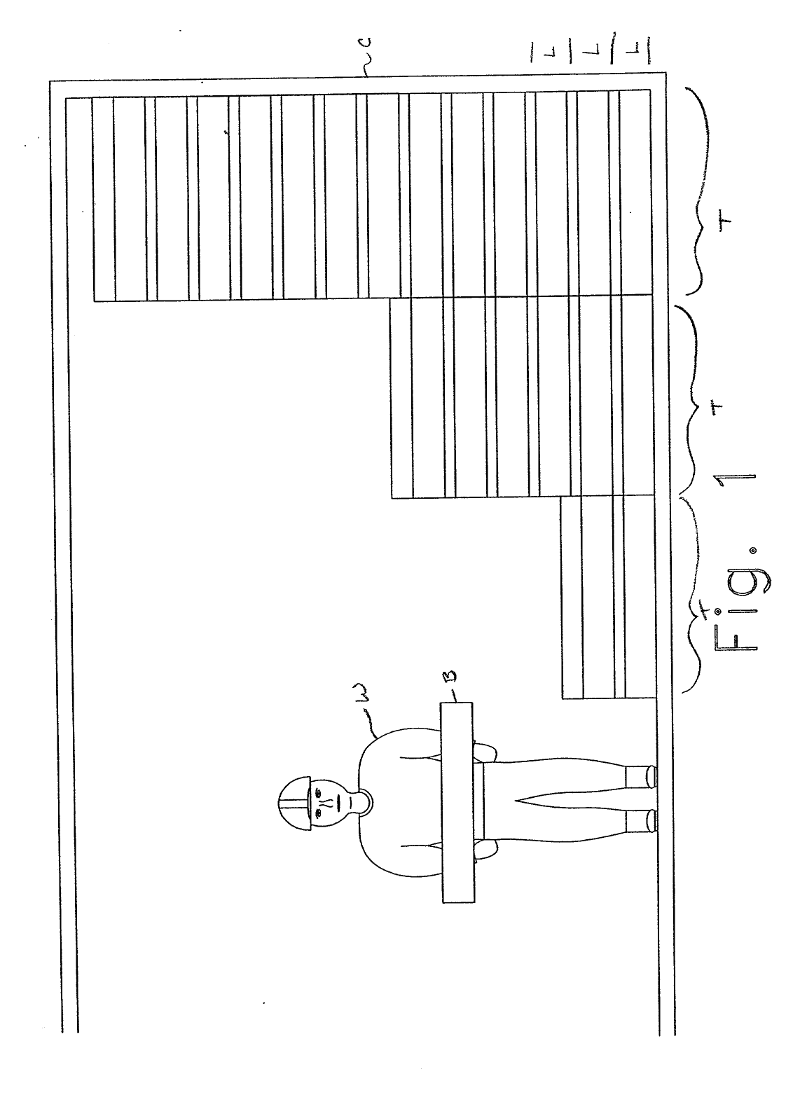

FIG. 1 is a schematic illustration of how shipping containers are typically loaded by hand stacking. By way of simplification, the term “bag” will be used to describe or denote any bag, box, or other container that can be handled by the stacking apparatus of the present invention. In addition, the term “shipping container” will be used to describe or denote any predefined space into which bags are to be stacked. Potential applications for the stacking apparatus of the present invention are therefore not to be limited to only those described herein.

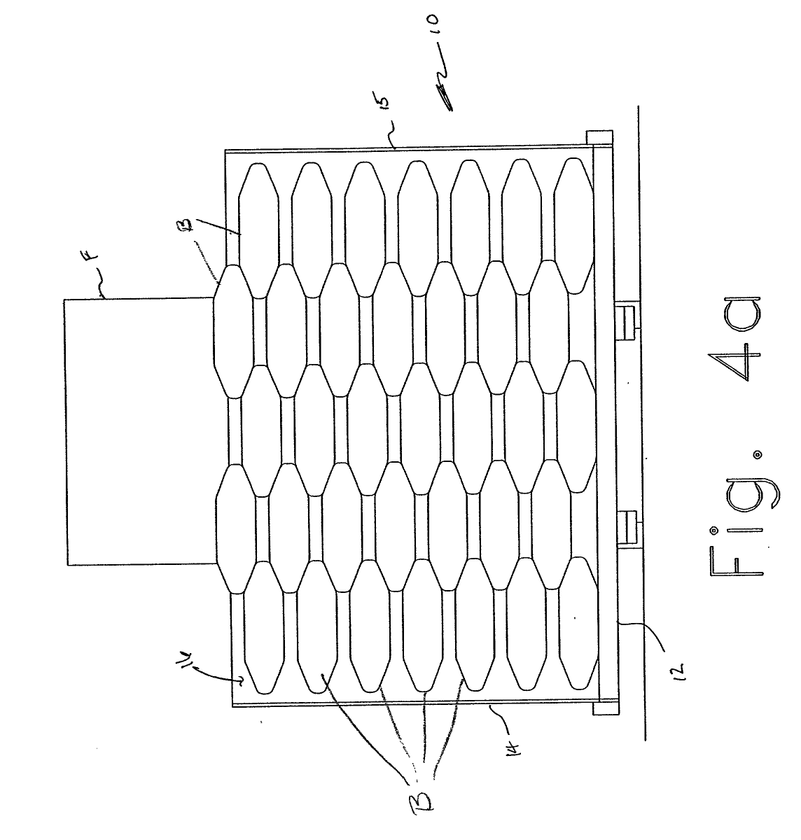

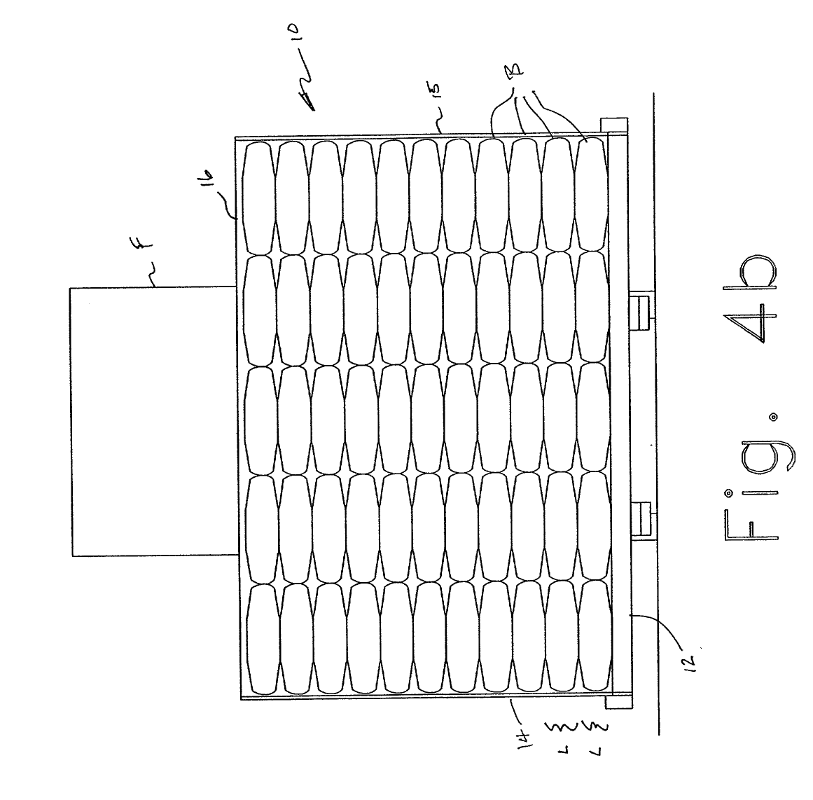

FIG. 1 is a schematic illustration of how bags B are typically hand stacked into a shipping container C, the bags B being stacked in the shipping container C in FIG. 1 are stacked in an interleaved or interlocked fashion as more clearly illustrated in FIG. 4a. In FIG. 1, the bags B are stacked in three tiers T of increasing height. The workman W begins filling the container C by laying a first layer L of bags B entirely across the width of the shipping container C. While it is possible for a workman to hand stack bags B in a single tier at a time, it is common practice to stack multiple tiers T so that the respective tiers T may be used as a sort of stair to access the highest tiers farthest into the container C. As can be appreciated from FIG. 1, hand stacking of bags B in a container C is an extremely labor intensive process and typically requires at least two individual workmen to accomplish the task.

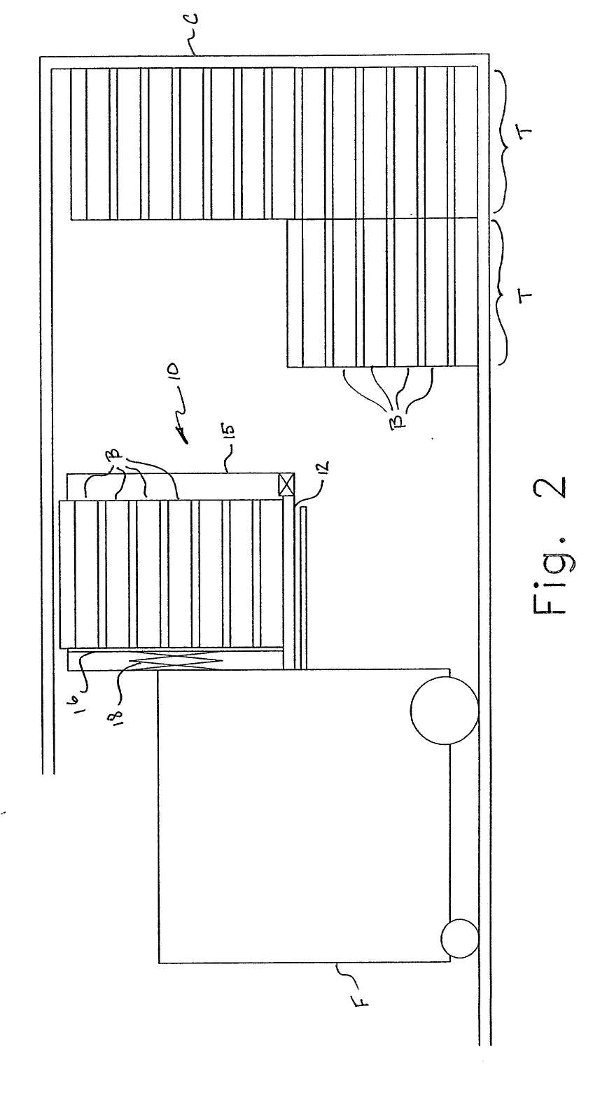

Because it is so labor intensive to hand stack bags B within a container C, it is preferred to use a materials handling apparatus such as fork truck F pictured in FIG. 2 to stack bags B within container C. FIG. 2 illustrates a fork truck F having mounted thereon a skid 10 of the present invention. Using the skid 10, it is possible to stack bags B quite rapidly within the container C without the need for hand stacking. In the embodiment illustrated in FIG. 2, it can be seen that the bags B may be stacked one-half tier T at a time. In order to facilitate the stacking, the skid 10 comprises a bottom 12 and sides 14, 15 that extend upwardly from the lateral edges of the bottom 12. The skid 10 further comprises a sliding back wall 16 that is constructed and arranged to move from a rearmost position as illustrated in FIG. 2 to a forward position adjacent the forward edge of the bottom 12. An actuating mechanism 18 is secured to the sliding back wall 16 of the skid 10 to move the back wall 16 between its rearmost and forward positions. The actuating mechanism 18 may comprise a scissors jack, a hydraulic cylinder, an air cylinder, or any other type of mechanism suitable for the application.

Bags B are stacked directly on bottom 12 of the skid 10 as illustrated in FIGS. 4a and 4b. Preferably, the bottom 12 of the skid 10 is fashioned of a durable and slippery material such as stainless steel. Note that any suitable material or coating may be placed upon bottom 12 in order to increase the durability and slipperiness of the bottom. As the sliding rear wall 16 moves from its rearmost position to its forward position under the impetus of the actuating mechanism 18, bags B stacked on the bottom 12 of the skid 10 are ejected from the skid 10. In operation, an operator of the fork truck F positions the skid 10 directly over the location in which the bags B are to be stacked. As illustrated in FIG. 2, this is directly over the leftmost half tier T stacked in the container C. Once the bags B on the skid 10 are aligned with the bags B of the remaining one-half tier T, the fork truck driver will simultaneously begin to reverse the fork truck F and actuate the actuating mechanism 18 such that, as the fork truck F moves backwards, the motion of the sliding back wall 16 from its rearmost to its forward positions maintains the bags B in their aligned relationship with the remaining bags B in the tier T. When the bottom 12 of the skid 10 has completely cleared the tier T as when the sliding back wall 16 has reached its forwardmost position, the bags B previously stacked within the skid 10 will have been completely ejected therefrom and will be positioned on the tier T. In this way, bags B may be stacked in tiers T within container C without the need for hand stacking. As can be appreciated, the use of multiple fork trucks F and skids 10 allows for the rapid stacking of bags B within container C.

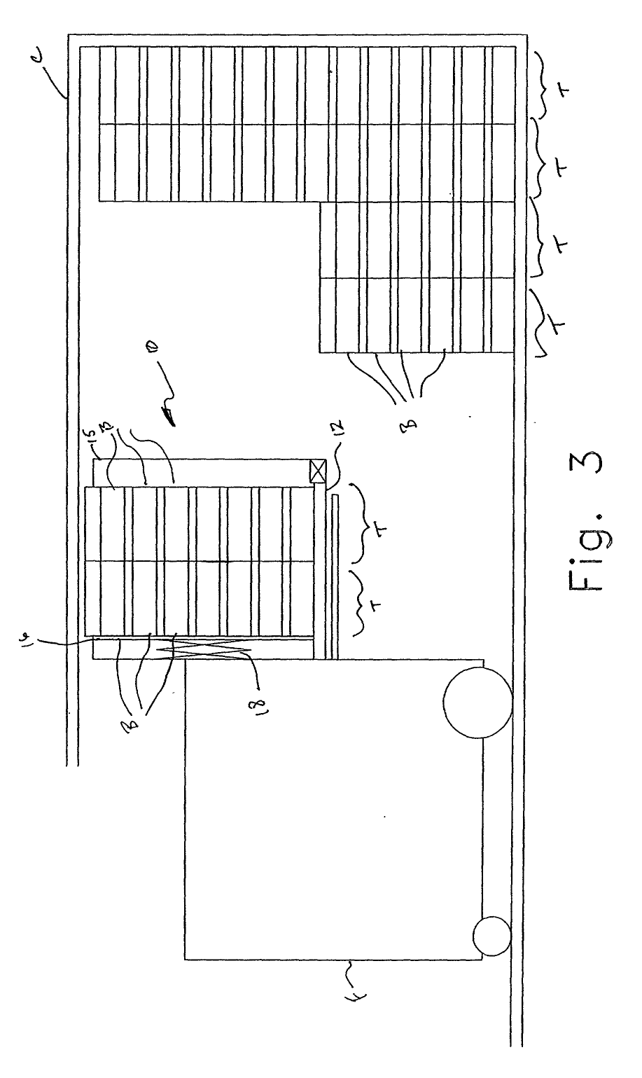

The bags B illustrated in FIG. 2 are relatively large bags ranging from between 50 to 100 pounds. Where bags of this size are being stacked within a container C, it is preferable to stack the bags B one tier T at a time. However, where, as illustrated in FIG. 3, smaller bags B are being stacked within a container C, it is possible to stack the bags B two tiers at a time. It is to be understood that, depending on the size and stacking arrangement of the bags B that is desired, any number of tiers T may be stacked in a single stacking operation.

FIGS. 4a and 4b illustrate two stacking arrangements for bags B. In FIG. 4a the bags B are stacked in an interlocking fashion with each bag being positioned within the interstices between the bags B on a layer L therebelow. FIG. 4b on the other hand illustrates bags B stacked within the skid 10 in a columnar fashion. Generally speaking, the interlocked stacking arrangement of the bags B illustrated in 4a is preferred as the resulting tiers of bags B are more stable than those resulting from the stacking arrangement illustrated in 4b. It is to be understood, however, that any stacking arrangement, whether interlocked, columnar or otherwise, is considered to be useable with the present invention.

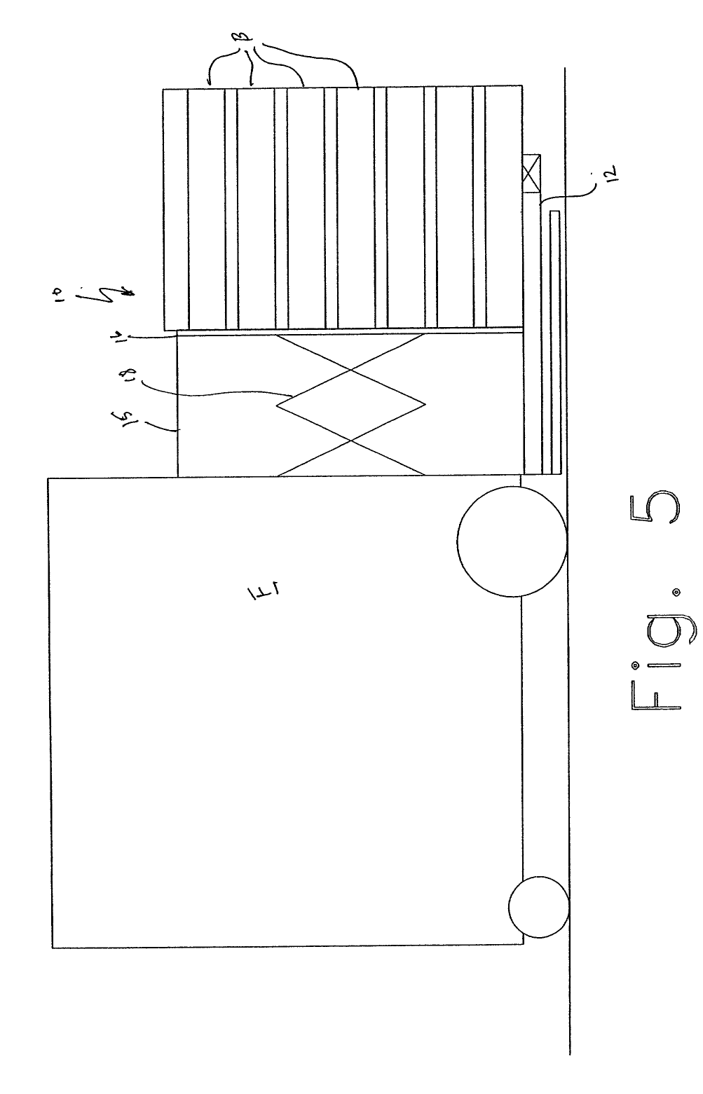

FIG. 5 illustrates how bags B are ejected from the skid 10. As can be seen, the actuation of the actuating mechanism 18 moves the sliding rear wall 16 of the skid 10 from its rearmost position as illustrated in FIGS. 2 and 3 towards a forwardmost position. As the rear wall 16 moves forward, bags B are slid off of the bottom 12 of the skid 10.

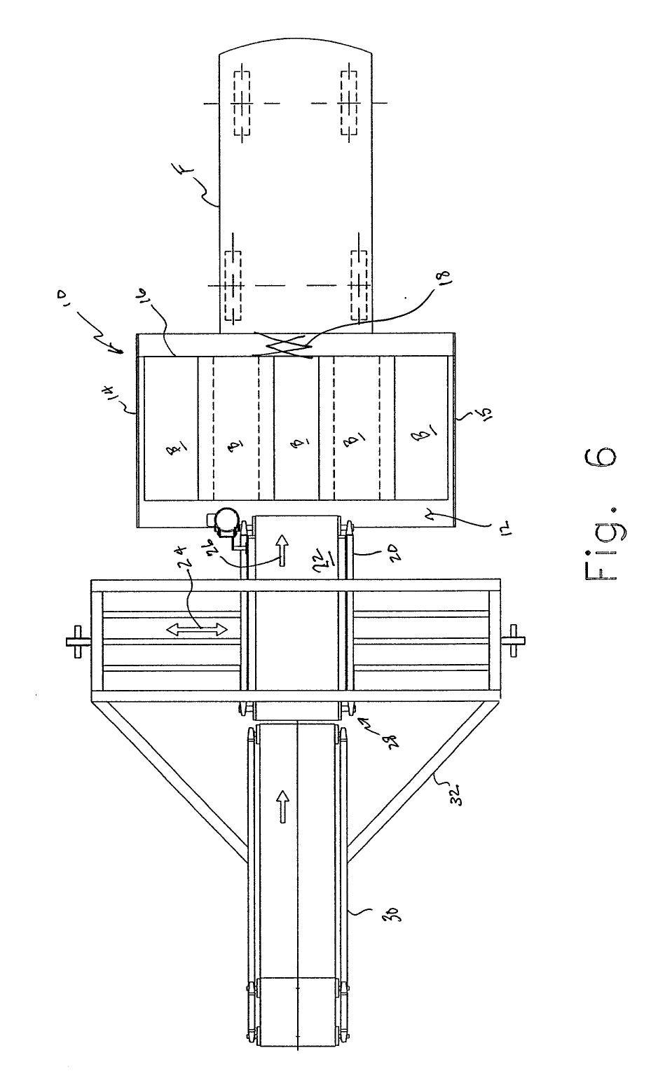

FIG. 6 is a top plan view of a first embodiment of the present invention. FIG. 6 illustrates a skid 10 being loaded with stacked bags B by stacking conveyor 20. The conveyor belt 22 conveys bags B onto the stack being formed in the skid 10. The conveyor 20 is moved laterally in a direction of arrow 24 with respect to the direction of travel of the conveyor belt 22 as illustrated by arrow 26. Stacking conveyor 20 is illustrated in its bag receiving position in FIG. 6. In this position, bags B may be received onto a bag receiving end 28 of the conveyor 20 from a supply conveyor 30. As can be appreciated, the conveyor 20 will then move laterally to a predetermined bag stacking position so that conveyor belt 22 of conveyor 20 may convey bag B onto the skid 10 into the predetermined stacking position. As can be appreciated from FIGS. 4a and 4b, each of the predetermined stacking positions corresponds to the position of a bag B in a layer L of bags.

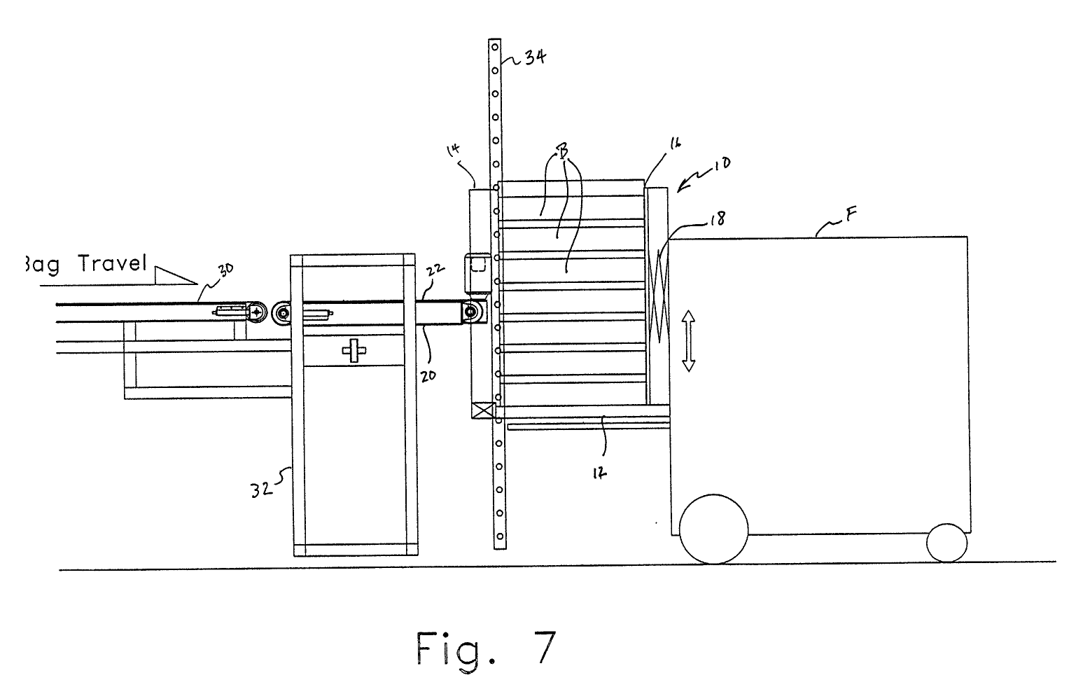

FIG. 7 illustrates a side view of the bag stacking apparatus of the present invention and illustrates how in this embodiment the conveyor 20 is supported upon a framework 32 at a height that is at or above the highest layer L of bags B stacked on the skid 10 when the skid 10 is in a position on or immediately adjacent to the floor. Stacking of the bags B on the skid 10 begins with the skid 10 in an uppermost position wherein the upper surface of the bottom 12 is substantially aligned with the top surface of the conveyor 20. Bags B conveyed by the conveyor belt 22 will slide directly onto the bottom 12 of the skid 10 when it is in this position. When bags B have filled all of the predetermined stacking positions on a given layer, i.e., the conveyor 20 has moved laterally so as to deposit a bag B in every predetermined stacking position in a given layer, the skid 10 will be lowered a distance equivalent to the height of a single layer L of bags B. The conveyor 20 will then move laterally to deposit bags B in each predefined stacking position on the subsequent layer L. This process repeats itself until a predetermined number of layers L of bags B have been deposited on the skid 10. Preferably, the lateral position of the conveyor 20 will be computer controlled, i.e., the predefined stacking positions of bag B will be automatically addressed by the conveyor 20 according to a predetermined arrangement. Alternatively, an operator or workman can control the lateral position of the conveyor 20 using a joy stick or similar device to move the conveyor 20 between the predefined stacking locations. The vertical position of the skid 10 in the embodiment illustrated in FIG. 7 is controlled by the operator of the fork truck F. While the vertical position of the skid 10 can be controlled by I, it is preferred to utilize an indicating device 34 that may be as simple as a strip of LEDs that light up to indicate the vertical position in which the skid must be placed. Alternatively, physical pointers may be used on the indicator 34.

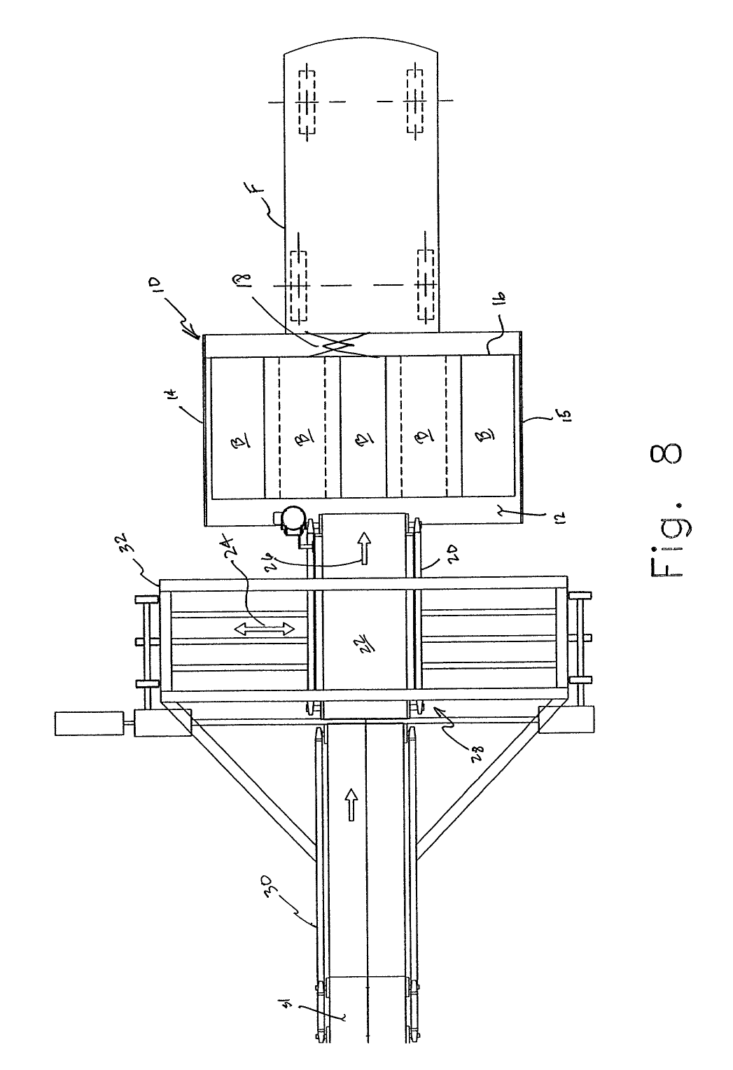

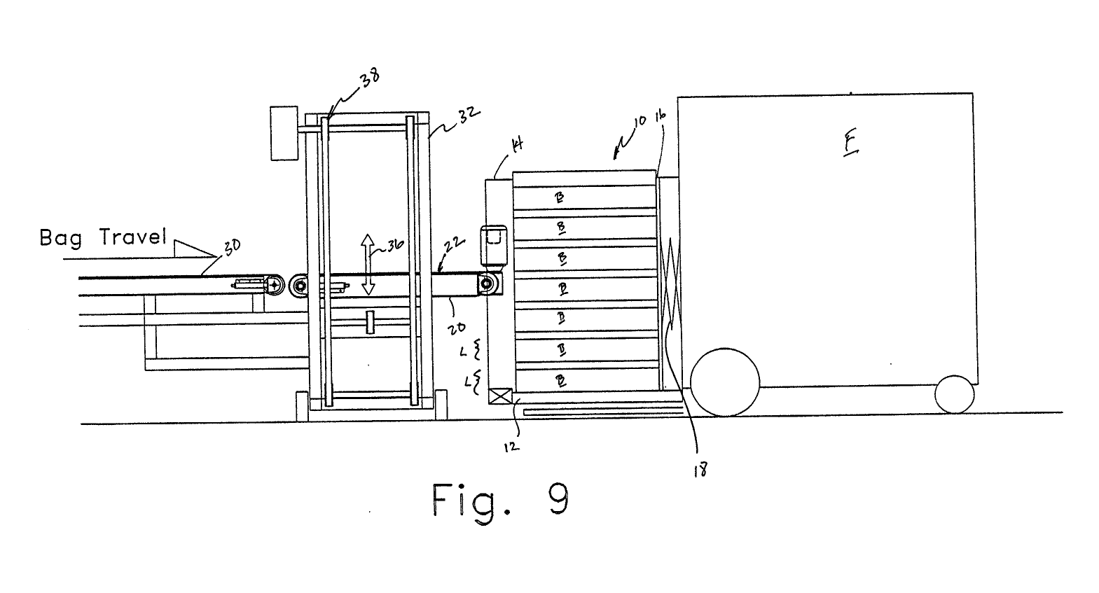

An alternate embodiment of the present invention is illustrated in FIGS. 8 and 9. The alternate embodiment illustrated in FIGS. 8 and 9 improves upon the embodiment illustrated in FIGS. 6 and 7 in that the conveyor 20 is also moveable in a vertical direction as indicated by arrow 36 in FIG. 9. The conveyor 20 is raised and lowered by lifting mechanism 38 that can be of any structure suitable for the purpose of raising and lowering the conveyor 20 while retaining the conveyor in a parallel relationship to the ground. Exemplars of mechanisms 38 may include but are not limited to Z belt linkages, hydraulic lifts, worm gear lifts and the like.

Because the conveyor 20 of the embodiment illustrated in FIGS. 8 and 9 is vertically moveable, the skid 10 will be placed in a loading position adjacent the output end of the conveyor belt 22 where it will remain during the entire stacking procedure. Accordingly, the conveyor 20 will be moved vertically and laterally with respect to the skid 10 in order to deposit bags B in the predetermined stacking positions required to stack the bags B on the skid 10 in a desired arrangement. Preferably, the position of the stacking conveyor 20 will be controlled by a computer controller or the like (not shown) so that the bags B will be stacked upon the skid 10 without the need for operator intervention. In this way, the stacking of bags B on the skid 10 will be repeatable, reliable, and relatively fast. However, it is conceivable that the position of the stacking conveyor 20 may also be controlled by an operator through the use of manual controls such as a joy stick or the like so that an operator or workman will move the stacking conveyor 20 to the various predefined stacking positions of the bags B. Note that in the embodiments illustrated in FIGS. 6 through 9, the stacking conveyor 20 must always return to a bag receiving position such that the bag receiving end 28 of the conveyor 20 is positioned such that bags B can be supplied to the stacking conveyor 20 from the supply conveyor 30.

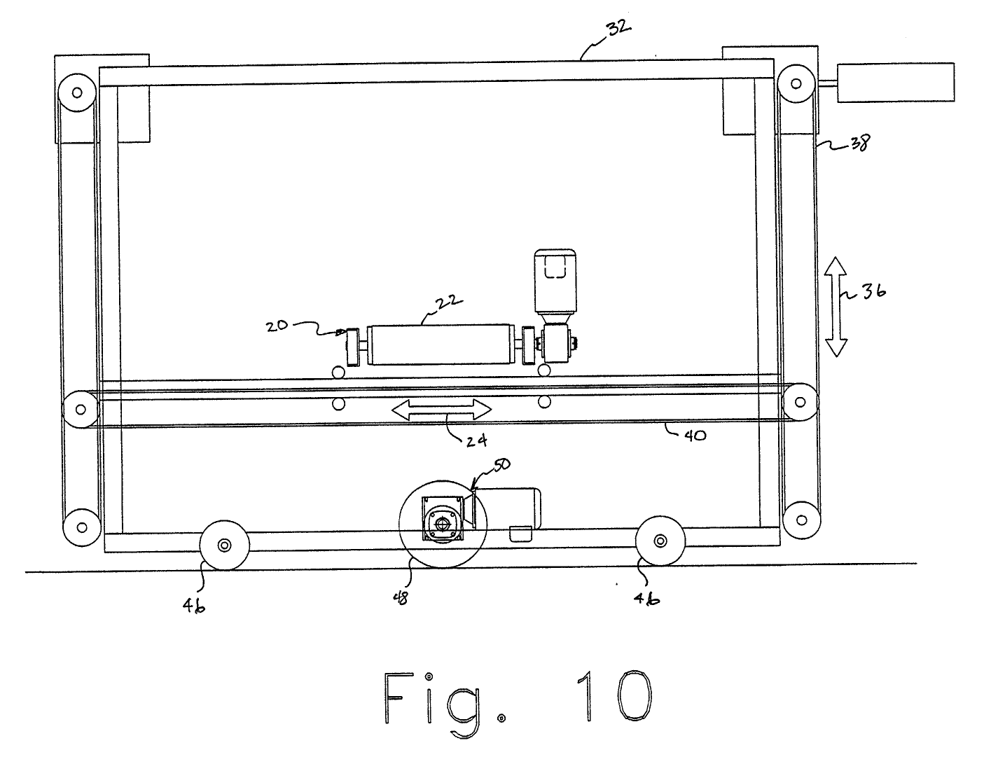

FIG. 10 is a front plan view of the stacking conveyor 20 and the framework 32 upon which it is supported. Arrows 24 and 36 illustrate the directions in which the conveyor 20 may be moved. Vertical positioning is controlled by the lifting mechanism 38 and lateral positioning (indicated by arrow 24) is controlled by the positioning mechanism 40.

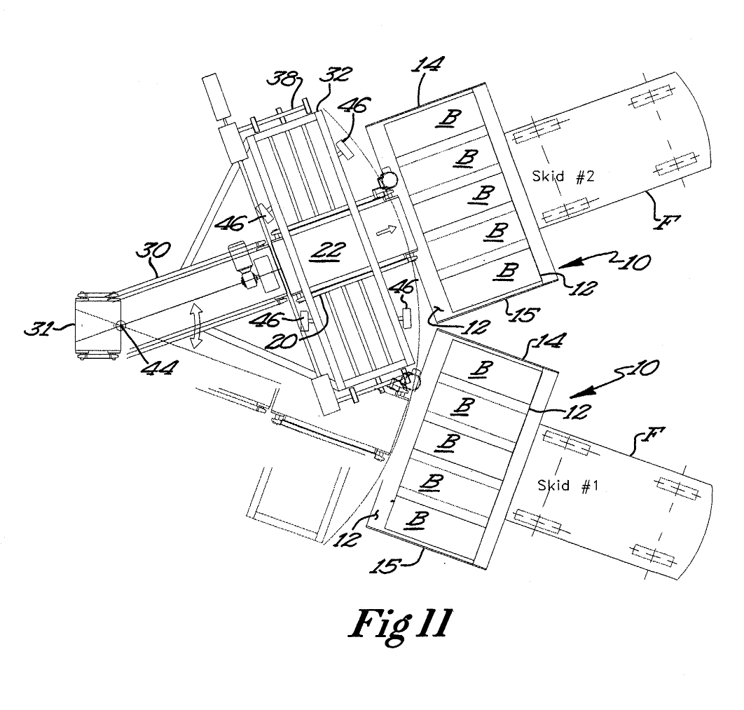

While it is possible to use only a single skid 10 in a loading operation, it is preferable to use more than one skid 10 such that while one skid is being unloaded into a container C, a second 10 is being loaded by the stacking conveyor 20. In another embodiment of the present invention, the stacking conveyor 20 can be mounted upon a moveable framework 32 as illustrated in FIGS. 10 and 11. As can be seen more clearly in FIG. 11, the moveable framework 32 can be rotated about pivot point 44 between a first stacking station and a second stacking station, the second stacking station being illustrated in dashed lines in FIG. 11. Note that any number of stacking stations may be utilized in the embodiment illustrated in FIGS. 10 and 11. The use of multiple stacking stations can enable the use of more skids 10, thereby speeding the loading of bags B into container C. Many different structures may be utilized to rotate or move the moveable framework 32 between multiple stacking stations. As illustrated in FIGS. 10 and 11, a preferred method whereby the framework 32 and hence the stacking conveyor 20 can be moved between stacking stations is to mount the framework 32 upon wheels 46. The wheels 46 may themselves be powered or may be free wheeling and a drive wheel 48 may be included. Drive wheel 48 will typically have a gear box and motor assembly 50 coupled thereto to provide mode of power to the wheel 48. Alternative structures for moving the framework 32 between stacking stations is to mount the framework 32 on rails, on skids, on tracks, or similar structures.

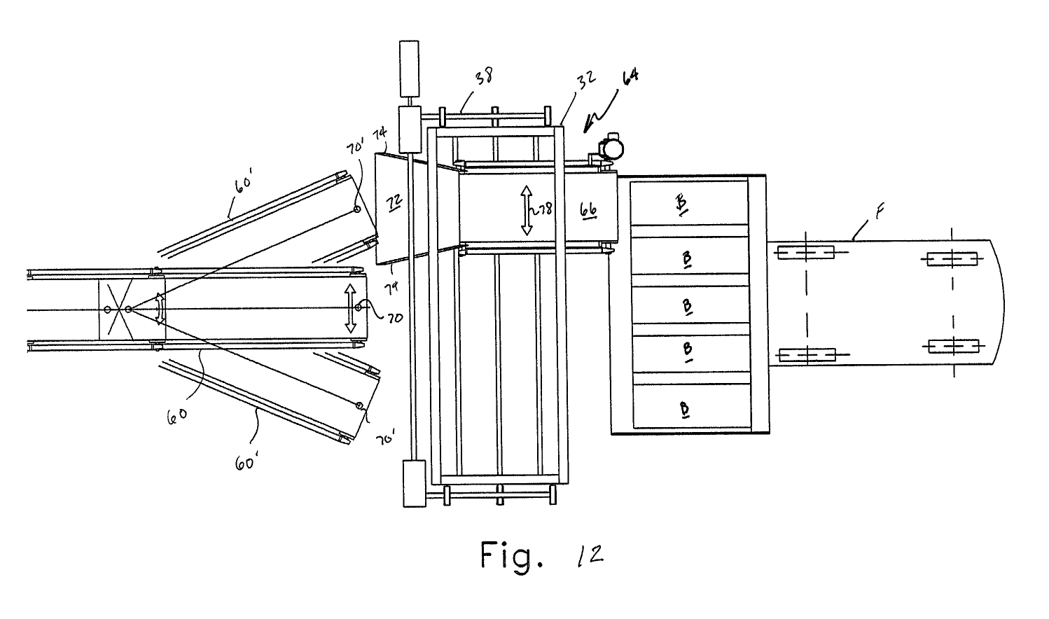

FIG. 12 illustrates an alternate embodiment of the present invention. The embodiment of FIG. 12 includes a self adjusting supply conveyor 60 having a first end that is rotatably and slidably mounted on a moveable support mechanism 62. The supply conveyor 60 has a second end that is constrained to move with the stacking conveyor assembly 64. Stacking conveyor assembly 64 comprises a conveyor 66 mounted upon a moveable platform 68. The second end of the conveyor 60 is rotatably connected to the platform 68 as by mounting pin 70. An alignment chute 72 has a receiving end that is disposed adjacent to the second end of the supply conveyor 60 such that a bag B conveyed from the supply conveyor 60 will be deposited directly into the alignment chute 72. Bags B may be deposited upon the alignment chute 72 in many attitudes. As each bag B slides down the alignment chute 72, the sides 74 of the chute 72 direct the bag B onto conveyor 66 such that the bag B is substantially aligned with the conveyor 66. Once the bag B is on conveyor 66, it is deposited in the skid 10 in one of a predefined stacking positions as described hereinabove in conjunction with FIGS. 6-11.

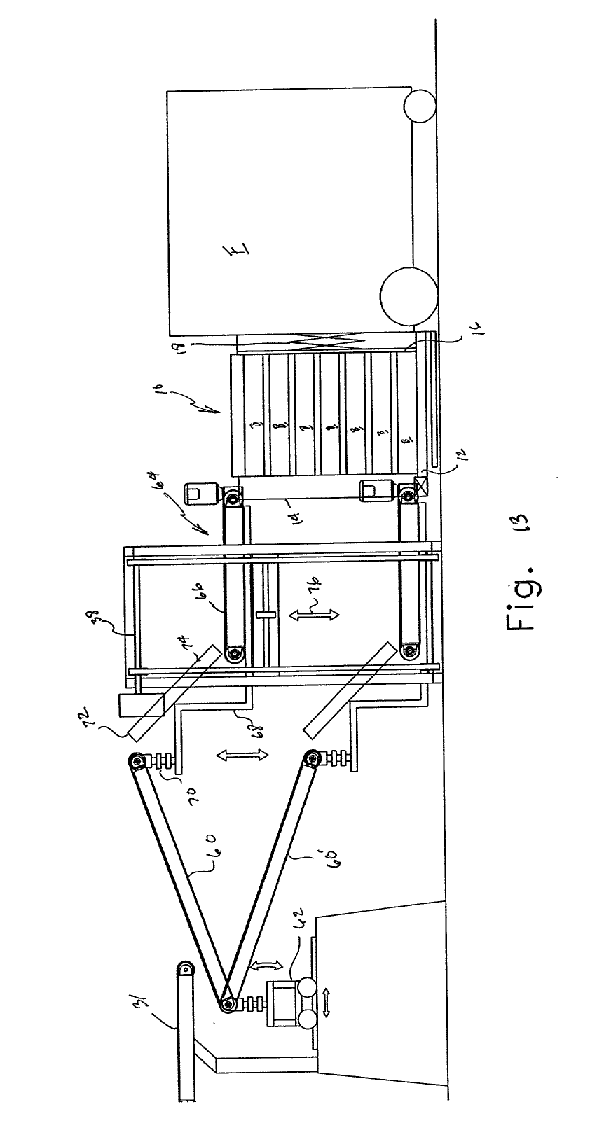

A stacking conveyor assembly 64 is moveable in both vertical and lateral directions as indicated by arrows 76 and 78, respectively. The use of the self adjusting supply conveyor 60 along with the alignment chute 72 permits the stacking conveyor assembly 64 to continuously stack bags B on the skid 10 without first having to return to a bag receiving position after each bag B has been deposited on the skid 10. Note that in FIGS. 12 and 13, reference numerals with a ‘prime’ are simply illustrating the various positions of the element in question.

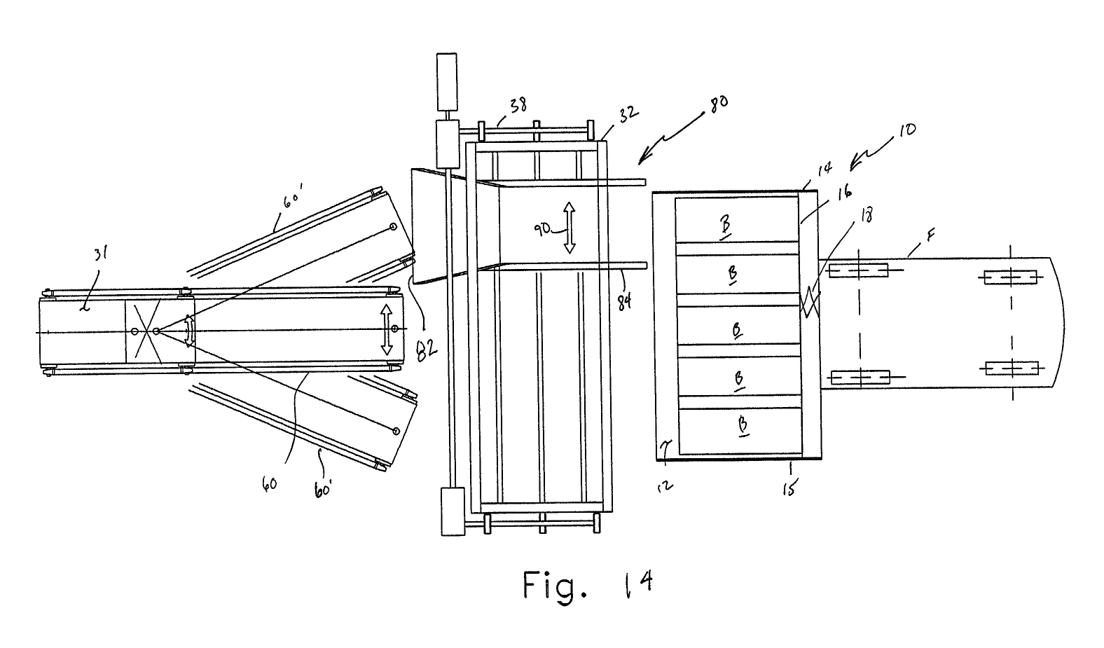

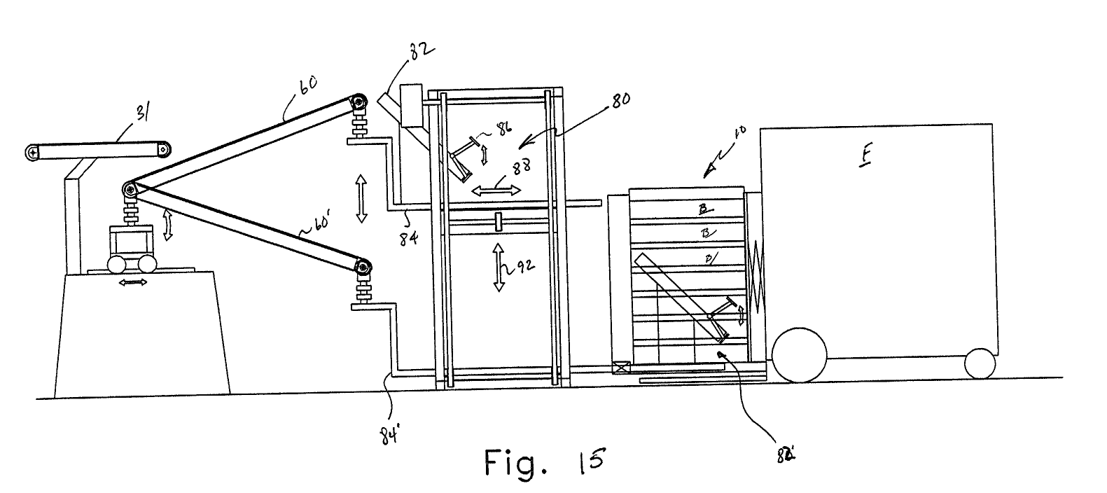

FIG. 14 illustrates another embodiment of the present invention that utilizes a chute in lieu of a stacking conveyor 60. Stacking chute assembly 80 comprises a moveable stacking chute 82 that is slidably mounted on a platform or frame 84. A bag gate 86, best seen in FIG. 15, is mounted to the stacking chute 82 and is rotatable between an open position in which bags B are free to slide down chute 82 unimpeded and a closed position in which the bag gate 86 prevents the bag B from exiting the chute 82. A self adjusting supply conveyor 60 is provided to supply bags B to the stacking chute 82. The first end of the supply conveyor 60 is rotatable mounted upon a moveable support mechanism 62 and the second end of the supply conveyor is rotatably secured to the platform or frame 84 by a mounting pin 70 as described in conjunction with FIGS. 12 and 13.

Platform or frame 84 of the stacking chute assembly is laterally and vertically moveable as indicated in FIGS. 14 and 15 by arrows 90 and 92 in the same manner as is the platform 68 of stacking conveyor assembly 60 described hereinabove. However, stacking chute 82 is also longitudinally moveable on the platform 84 in the directions indicated by arrow 88 in FIG. 15. The degrees of freedom of the stacking chute 82 indicated by the arrows 88, 90, and 92 permit bags B to be placed in the predefined stacking positions described herein above. Note that in FIGS. 14 and 15 reference numerals with a ‘prime’ are simply illustrating the various positions of the element in question.

In operation, the stacking chute 82 of the stacking chute assembly 80 receives a bag B from the supply conveyor 60 as described above. As the bag B slides down the chute 82, bag gate 86 stops the bag B and retains it on the chute 82. Chute 82 then moves forward on the platform 84 (by means of wheels, rails, or similar mechanisms) to one of the predefined bag stacking positions as illustrated in FIG. 15 at 82¹. When the chute 82 has been located in a desired bag stacking position, the bag gate 86 moves to its open position and the bag B is allowed to slide into its position on the skid 10 as the chute 82 is simultaneously moved back to its bag receiving position. This process repeats itself until the skid 10 has been filled.

It is to be noted that in the illustrations, a small conveyor is arranged above the first or input end of the supply conveyor 30,60. This small conveyor 31 may be rigid or extendable and may be a powered or unpowered conveyor or other materials handling device. In addition, the general arrangement of the small conveyor 31 and the supply conveyor 30, 30 to the stacking conveyor or chute is generally illustrated as being roughly aligned. However, it is to be understood that the alignment of the various components may take diverse shapes, limited only by the nature of the conveying devices being used.

Another embodiment of the present invention omits the use of a skid 10 in the stacking of bags B. In this embodiment (not shown), the framework 32 upon which the stacking conveyor or chute is mounted, as well as the supply conveyor or mechanism 60, is mounted upon tracks, treads, wheels, or the like. An extendable conveyor, powered or unpowered, supplies bags B to the supply mechanism 60. Moving on its treads or wheels, the framework 32 is positioned at an unloading position, e.g. in a container C, so that the bags B are stacked directly in the container C without the need for a skid 10. Again, it is preferred that the operation of the stacking apparatus, whether mobile or stationary, be controlled by computer. However, it is envisioned that direct user operation may be used in place of computer control of the stacking device.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. An apparatus for creating an ordered stack of bags in a predefined arrangement, the apparatus comprising:
a. a conveying mechanism having an input end and an output end, the conveying mechanism being laterally moveable with respect to the direction of travel of bags from the input end to the output end of the conveying mechanism such that the conveying mechanism may move to a bag pick up position in which a bag may be received from a bag supply mechanism to one of a number of predefined bag deposition positions in which the output end of the conveying mechanism is placed to deposit a bag in a predefined stack position; and,
b. a queuing mechanism for receiving bags from the output end of the conveying mechanism, the queuing mechanism having a bottom, two opposing sides extending upwardly from the lateral edges of the bottom and a back wall positioned between the sides and moveable between a rearmost position located away from the conveying mechanism and in which the bags may be deposited upon the bottom of the queuing mechanism between the opposing sides of the queuing mechanism in a predetermined arrangement, and a forward position located near the conveying mechanism, the back wall expelling stacked bags from the queuing mechanism in moving from its rearmost position to its forward position, the queuing mechanism being vertically moveable with respect to the conveying mechanism such that successive layers of bags may be deposited within the queuing mechanism by the conveying mechanism.

2. The apparatus for creating an ordered stack of bags of claim 1 wherein the conveying mechanism is a first powered conveyor that is constructed and arranged to receive bags from a second powered conveyor.

3. The apparatus for creating an ordered stack of bags of claim 1 wherein the queuing mechanism is mounted to a materials handling vehicle that is capable of moving the queuing mechanism from a loading position wherein the queuing mechanism is positioned adjacent the conveying device to a stacking position wherein bags stacked on the queuing device are expelled from the queuing device by the movement of the back wall of the queuing device from its rearmost position to its forward position.

4. The apparatus for creating an ordered stack of bags of claim 3 wherein the loading position of the queuing mechanism is one of a railcar, a shipping container, a truck trailer, and a warehouse bay.

5. The apparatus for creating an ordered stack of bags of claim 1 wherein the conveying mechanism is capable of conveying bags at a speed sufficient to convey a bag entirely onto the queuing mechanism.

6. The apparatus for creating an ordered stack of bags of claim 20 wherein the queuing mechanism further comprises an indicating mechanism for conveying positioning information concerning the position of the queuing device with respect to the conveying mechanism.

7. The apparatus for creating an ordered stack of bags of claim 20 wherein the conveying mechanism is moveable between at least two queuing mechanism stations.

8. The apparatus for creating an ordered stack of bags of claim 20 wherein the conveying mechanism is constructed and arranged for vertical and lateral movement.

9. An apparatus for creating an ordered stack of bags comprising:
a. a conveyor mounted within a framework constructed and arranged such that the conveyor is moveable vertically and laterally with respect to the framework, the conveyor having an input end and an output end;
b. a skid having a bottom, two opposing sides extending upwardly from the lateral edges of the bottom, and a back wall moveable between a first position located adjacent a back edge of the skid and a second position located adjacent a front edge of the skid; and,
c. wherein the conveyor is moveable from a bag receiving position in which a filled bag is deposited on the input end of the conveyor and one of a number of vertically and laterally predefined stacking positions in which the conveyor conveys the filled bag onto the skid in one of the predefined stacking positions.

10. The apparatus for creating an ordered stack of bags of claim 9 wherein the back wall of the skid is in its first position as filled bags are deposited on the skid by the output end of the conveyor, the bags deposited on the skid being expelled therefrom as the back wall moves from its first position to its second position.

11. The apparatus for creating an ordered stack of bags of claim 9 wherein the skid remains stationary as filled bags are deposited thereon by the moveable conveyor.

12. The apparatus for creating an ordered stack of bags of claim 9 wherein the skid is mounted to a materials handling device capable of moving the skid from a loading position adjacent the output end of the conveyor to an unloading position where the filled bags stacked on the skid are expelled therefrom by the action of the back wall moving from its first position to its second position.

13. The apparatus for creating an ordered stack of bags of claim 12 wherein the filled bags stacked on the skid are expelled into one of a shipping container, an airplane cargo hold, a warehouse bay, a railcar, a trailer, and a hold of a ship.

14. The apparatus for creating an ordered stack of bags of claim 9 wherein the filled bags are stacked in an interlocked fashion.

15. The apparatus for creating an ordered stack of bags of claim 9 wherein the filled bags are stacked in columns.

16. The apparatus for creating an ordered stack of bags of claim 9 wherein the 10 filled bags are stacked in tiers.

17. The apparatus for creating an ordered stack of bags of claim 9 further comprising a controlling mechanism that directs the conveyor between its bag receiving position and its number of vertically and laterally predefined stacking positions.

18. The apparatus for creating an ordered stack of bags of claim 17 wherein the controlling mechanism is a computer controller.

19. The apparatus for creating an ordered stack of bags of claim 17 wherein the controlling mechanism is a joystick that is manually operated to move the conveyor between its bag receiving position and its number of vertically and laterally predefined stacking positions.

20. An apparatus for creating an ordered stack of bags comprising:
a. a conveyor mounted within a framework constructed and arranged such that the conveyor is moveable along a substantially vertical axis and laterally with respect to the vertical axis, the conveyor having an input end and an output end;
b. a skid having a bottom, two opposing sides extending upwardly from the lateral edges of the bottom, and a back wall moveable between a first position located adjacent a back edge of the skid and a second position located adjacent a front edge of the skid;
c. a support mechanism for moveably supporting the framework, the support mechanism being constructed and arranged to move the conveyor between a plurality of stacking stations; and,
d. wherein the conveyor is moveable from a bag receiving position in which a filled bag is deposited on the input end of the conveyor and one of a number of vertically and laterally predefined stacking positions in which the conveyor conveys the filled bag onto the skid in one of the predefined stacking positions.

21. The apparatus for creating an ordered stack of bags of claim 20 wherein the support mechanism supports the framework upon one of rails, wheels, and treads.

22. The apparatus for creating an ordered stack of bags of claim 20 wherein the support mechanism moves the framework between the plurality of stacking stations along one of a linear and a curvilinear path.

23. An apparatus for creating an ordered stack of bags comprising:
a. a conveying mechanism mounted within a framework and constructed and arranged such that the conveying mechanism is moveable within the framework vertically and laterally, the conveying mechanism having an input end and an output end; and,
b. a self aligning supply mechanism having a first end mounted upon and rotatable about a moveable mounting structure, and a second end that is constrained to move with the input end of the conveying mechanism such that an object may be conveyed from the second end of the conveying mechanism to the input end of the conveying mechanism regardless of the vertical and lateral position of the conveying mechanism within the framework.

24. The apparatus for creating an ordered stack of bags of claim 23 further comprising a skid having a bottom, two opposing sides extending upwardly from the lateral edges of the bottom, and a back wall moveable between a first position located adjacent a back edge of the skid and a second position located adjacent a front edge of the skid and wherein the conveying mechanism is moveable between a number of vertically and laterally predefined stacking positions in which the conveying mechanism conveys a filled bag onto the skid in one of the predefined stacking positions.

25. The apparatus for creating an ordered stack of bags of claim 23 further comprising an infeed conveyor having a deposition end posited generally above the first end of the self adjusting supply mechanism such that objects conveyed from the deposition end of the infeed conveyor are deposited on the first end of the supply mechanism.

26. The apparatus for creating an ordered stack of bags of claim 23 wherein the moveable mounting structure is free to move in a generally longitudinal direction with respect to the supply mechanism to account for lateral movements of the second end of the supply mechanism.

27. The apparatus for creating an ordered stack of bags of claim 23 wherein the conveying mechanism is a powered stacking conveyor.

28. The apparatus for creating an ordered stack of bags of claim 27 wherein the conveying mechanism further comprises an alignment chute disposed between the second end of the supply mechanism and an input end of the powered stacking conveyor.

29. The apparatus for creating an ordered stack of bags of claim 23 wherein the conveying mechanism is a gravity powered conveying mechanism selected from one of a chute and a roller conveyor.

30. The apparatus for creating an ordered stack of bags of claim 29 wherein the conveying mechanism further comprises a gate mechanism for preventing the egress of objects from the conveying mechanism.

31. The apparatus for creating an ordered stack of bags of claim 29 wherein the conveying mechanism is moveable between a bag receiving position in which a bag deposited on the conveying mechanism by the supply mechanism and a bag stacking position in which a bag is deposited in one of the predefined stacking positions.

32. An apparatus for creating an ordered stack of bags comprising:
a. a conveyor mounted within a framework and being constructed and arranged such that the conveyor is moveable vertically and laterally with respect to the framework, the conveyor having an input end and an output end; and,
b. a supply mechanism having a output end that is positioned adjacent a bag receiving position of the conveyor such that when the conveyor is in its bag receiving position, a bag may be deposited on the input end of the conveyor from the output end of the supply mechanism.

33. The apparatus for creating an ordered stack of bags of claim 32 further comprising a skid having a bottom, two opposing sides extending upwardly from the lateral edges of the bottom, and a back wall moveable between a first position located adjacent a back edge of the skid and a second position located adjacent a front edge of the skid, the skid being constructed and arranged to receive one or more bags from the conveyor in a predefined stacking patter and to expel the stacked bags therefrom in a chose stacking location and wherein the conveyor is moveable from a bag receiving position in which a filled bag is deposited on the input end of the conveyor and one of a number of vertically and laterally predefined stacking positions in which the conveyor conveys the filled bag onto the skid in one of the predefined stacking positions.

34. The apparatus for creating an ordered stack of bags of claim 32 wherein the conveyor is moveable from a bag receiving position in which a filled bag is deposited on the input end of the conveyor and one of a number of vertically and laterally predefined stacking positions in which the conveyor conveys the filled bag into one of the predefined stacking positions.

35. The apparatus for creating an ordered stack of bags of claim 34 wherein said predefined stacking positions are located on a stacking skid.
